(19) United States
(12) Patent Application Publication
(10) Pub. No.: US 2002/0070165 A1
(43) Pub. Date: Jun. 13, 2002

(54) METHOD FOR THE PURIFICATION AND RECOVERY OF WASTE GELATIN

(76) Inventor: WILLIAM J. SCHMIDT, DRESHER, PA (US)

Correspondence Address: WATOV & KIPNES PC, P O BOX 247, PRINCETON JUNCTION, NJ, 08550

(21) Appl. No.: 09/385,405

(22) Filed: Aug. 30, 1999

Related U.S. Application Data
(60) Provisional application No. 60/108,584, filed on Nov. 16, 1998.
(60) Provisional application No. 60/128,115, filed on Apr. 7, 1999.
(60) Provisional application No. 60/141,332, filed on Jun. 28, 1999.

(51) Int. Cl. B01D 11/00

(52) U.S. Cl. 210/634; 210/652; 210/774; 210/806

(57) ABSTRACT

Method and apparatus for treating a waste material containing gelatin in which the waste material is combined with a solvent capable of dissolving the gelatin and any softening agent contained therein and then treating the solvent based layer to remove oils and particulates which may be present to provide a recoverable and usable gelatin containing stream.

### RELATED APPLICATIONS

This application relies for priority purposes on U.S. Provisional Patent Application No. 60/108,584 filed on Nov. 16, 1998; No. 60/128,115 filed on Apr. 7, 1999; and No. 60/141,332 filed on Jun. 28, 1999. The present application is also a Continuation-In-Part Application of U.S. Serial No. (NOT AVAILABLE) filed on Aug. 26, 1999, which is a Continuation-In-Part Application of U.S. Ser. No. 09/259,726 filed on Mar. 1, 1999, which is a Continuation-In-Part Application of U.S. Ser. No. 09/033,679 filed on Mar. 3, 1998, now U.S. Pat. No. 5,945,001.

### FIELD OF THE INVENTION

This invention is generally directed to a process for recycling gelatin waste made from gelatin and derivatives thereof and in particular, to a process for recycling gelatin waste, its derivatives, and components contained within gelatin waste resulting from industrial encapsulation processes.

### BACKGROUND OF THE INVENTION

Gelatin and gelatin derivatives are used to encapsulate the products of several industries. Examples are described in U.S. Pat. No. 5,074,102, issued to Simpson et al, and include the encapsulation of medicinal compounds such as drugs and vitamins; employment of gelatin encapsulation in food packaging, such as for powdered instant coffee or spices; in candy manufacturing; in fertilization of ornamental plants and/or indoor plants; in packaging of sensitive seeds in combination with protective agents and/or fertilizers; and in the packing of single dyestuffs or mixtures of various drugs.

In each of the above-recited manufacturing and production processes, a certain amount of the encapsulating material and the encapsulated material (e.g. vitamins) is lost as waste. Frequently, the amount lost as waste of the encapsulating material approaches 50% or more of the total starting material, depending on the arrangement of production employed. When considering that the cost of the encapsulating material in the United States averages approximately $3.10 per pound ($6.82 per kilo) as of September, 1997, it is clear that the economic consequences of such waste can be significant. As a result, manufacturers have attempted to off-set poor production efficiency by recycling the waste material for reuse. Such attempts, however, have not been met with a great deal of success.

Prior art methods of gelatin recovery and purification suffer from a variety of shortcomings to be discussed in further detail below. Before these shortcomings can be fully appreciated, however, the composition of the encapsulation waste material itself should be further understood. In general, waste material of encapsulation processes is comprised of a variable number of components added to a gelatin base. Among them are solvents (usually water); softening agents and oil coatings (when desired); and, contaminants in the form of residual active ingredients, i.e. the substance being encapsulated. In addition, colorings and preservatives may also be added. Thus, it can be observed that successful recycling involves not only the recovery of gelatin from surrounding oils, but also the removal of the remaining components of the waste in order to achieve a relatively pure, reusable product.

Extraction has been the principle method for accomplishing removal of oils, actives and the like in the pharmaceutical industry. While several solvents have been used in the prior art in an effort to accomplish separation, each suffer from a variety of shortcomings not the least of which is the necessity of ultimately removing yet another component, i.e. the solvent itself, from the recycled materials. To date, the most popular and widely used solvents used to separate gelatin from oils and actives are chlorinated solvents such as, for example, 1,1,1,-trichloroethane with naphtha. The use of chlorinated solvents, however, is accompanied by high costs, disposal problems, and most importantly, environmental concerns. Attempts have been made to use other solvents including isopropyl alcohol, methyl isobutyl ketone, toluene, hexane, heptane, acetone, and acetone/water mixtures, but the resulting yields are insufficient and/or the separation is poor. Furthermore, some of these chemicals are relatively expensive and present similar environmental, disposal, and safety concerns as the chlorinated solvents. None of them have been found to separate oils and actives with a high degree of efficiency.

U.S. Pat. No. 5,288,408, issued to Schmidt et al, discloses a method of recycling gelatin-based encapsulation waste material, and more specifically, to a process for the recovery and purification of gelatin and softening agents therefrom. In the preferred embodiment, deionized water is added to the waste material thereby forming an aqueous solution of gelatin and glycerin dispersed within the remaining oil and residual active-ingredient components of the waste material. Extraction methods are employed under specific conditions to effect separation of the lower aqueous phase from the upper oil phase. The lower phase is hot filtered to remove any remaining traces of oil or other contaminants and the filtrate is then charged to a concentration vessel adapted for vacuum distillation. The water solvent is thus removed under specific thermal and atmospheric conditions until the desired concentration of gelatin and glycerin is achieved. A pure, concentrated aqueous gelatin-glycerin solution results which may be stored or further prepared for immediate reuse. Although this process lends itself to the removal of dyes and active ingredients with additional chemical reactions and processing, such dyes, active ingredients, and glycerin are not removed in situ.

Clear gelatin contains no dye, colorants or the like. It is used to make clear gelatin capsules in the pharmaceutical, neutraceutical, and nutrient industries and other industries as well. Because dyes are not present, there is a need to provide a cost efficient and effective manner for recycling the gelatin and glycerin for reuse. Gelatin may have suspended particles such as titanium dioxide which impart a color to the gelatin. Such particles can be more easily removed from the waste gelatin than dyes and colorants which are water soluble.

It would, therefore, be desirable to provide a method for recycling gelatin-based encapsulation waste material that recycles gelatin and glycerin in situ without the need for any additional processing. It would be a further advance in the art of recycling waste gelatin if an in situ process could be developed that is especially effective in recycling gelatin and gelatin containing suspended particles without thermal degradation in a cost efficient and effective manner. It would be a still further advance in the art to provide a cost efficient and effective method of recycling gelatin whether clear or colored and whether or not the gelatin contains suspended particles (e.g. a colorant).

It would be a still further advance in the art to provide a method of recovering valuable components from a waste gelatin recovery process.

### SUMMARY OF THE INVENTION

The present invention is generally directed to the recovery of waste gelatin alone or in combination with other components of a waste gelatin product through the separation and treatment of a waste gelatin stream into an aqueous and non-aqueous substream.

In one aspect of the present invention there is provided a method of treating a waste material containing gelatin comprising:

a) combining the waste material and a solvent for the gelatin to form a liquid containing gelatin;

b) separating the liquid into a solvent based phase or layer and a non-solvent based phase or layer; and

c) removing residual oils and/or particulates from the solvent based layer to form a second liquid containing gelatin having a higher purity than the first liquid.

### DETAILED DESCRIPTION OF THE PREFERRED EMBODIMENTS

Gelatin is a protein derivative of collagen obtained, in general, by the boiling of skin, white connective tissues, and bones of animals, and by the partial hydrolysis of collagen, in particular. As a colloid it has unique physical properties. Of particular significance to the present invention is its tendency to stay in solution and its ability to form dispersions in oils. Gelatin remains a solid at standard atmospheric pressure and temperature absent the presence of a sufficient quantity of solvent.

Softening agents are sometimes added to plasticize the gelatin when soft, gelatin shells are desired. Agents such as glycerin, sorbitol, or other similar polyols are commonly employed as softening agents. Glycerin is a preferred softening agent.

The soft elastic capsule-forming material may be used to enclose active components in the form of powders, liquids, or combinations thereof. Oils, such as vitamin A, vitamin E, and beta-carotene, for example, are frequently encapsulated by such soft gel materials in the pharmaceutical, cosmetic, and nutritional industries. Additionally, other oils like mineral oil or medium chain triglycerides (MCT's) may be used to coat the outer surface of the gel-capsule during processing. Thus, it can be seen that the waste product of the encapsulation process may have, in addition to gelatin and a softening agent such as glycerin, many components (e.g. oily components) which must be removed before the gelatin waste is available for reuse as a relatively pure product. In some instances, coloring agents and preservatives may also be incorporated into the gelatin mass. Commonly used preservatives include methylparaben, propylparaben, and sorbic acid.

Present methods of encapsulating active components employ a ribbon or sheet of gelatin which is then die punched to form capsules. As much as 50% or more of the gelatin starting material (i.e. gelatin ribbon) is either discarded as a waste by-product or recycled. The latter option requires the removal of all of the above-mentioned components. The present invention provides a novel and efficient method of purifying and recycling the waste material without experiencing the shortcomings of the prior art. It will be understood that other proteins with physical and chemical properties similar to gelatin exist and may also be recycled by the present process. Similarly, glycerin is only one example of a softening agent which may be recovered; thus, neither gelatin nor glycerin are intended to be limiting.

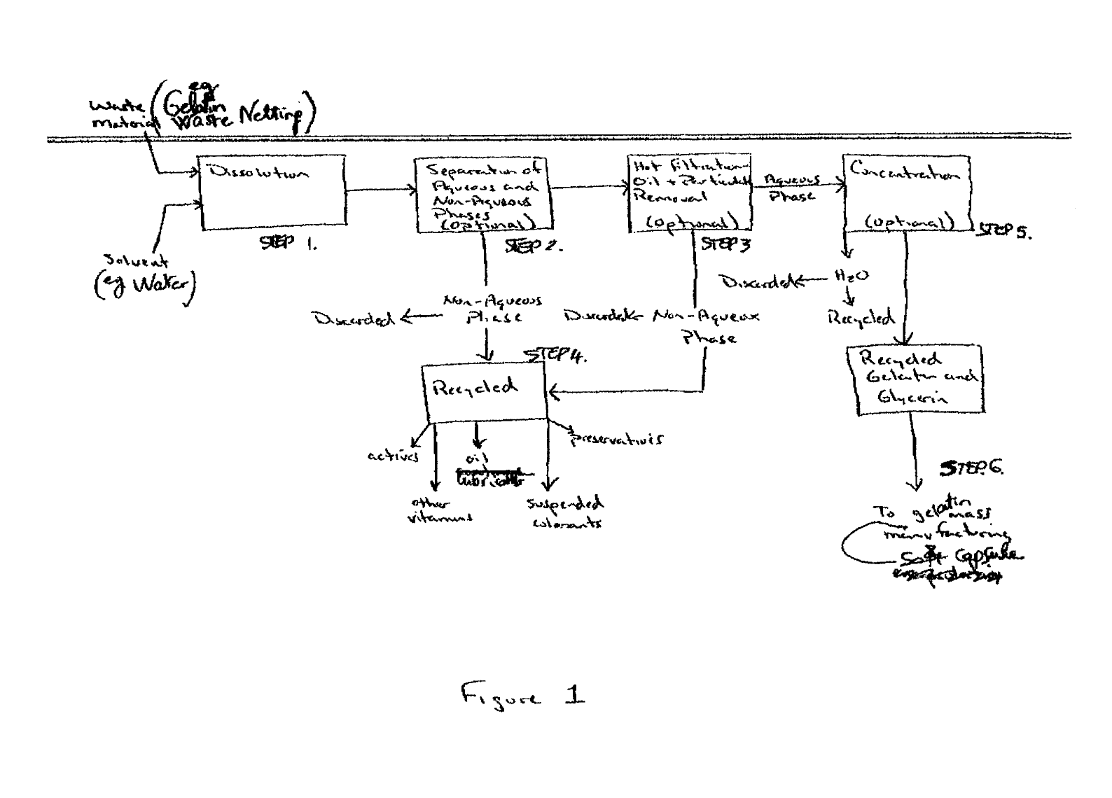

Reference is now made to FIG. 1 wherein an embodiment of the present invention for the purification and recovery of gelatin and/or glycerin is illustrated. A suitable solvent such as deionized (D.I.) water in an amount sufficient to dissolve the waste gelatin material, typically in an amount of up to about five volumes, based on the quantity of waste gelatin, preferably from about 0.5 to 5.0 volumes is added to a dissolution/separation vessel which may be provided with a heating jacket known in the art. The waste gelatin material which may be preheated to a temperature of from about 30 to 70° C. to make the waste gelatin in a convenient flowable condition, is then charged either batchwise or continuously to the dissolution/separation vessel which may be made of stainless steel or glass-lined construction and sized according to a desired batch size. The dissolution/separation vessel may also be provided with a conventional agitation device such as a stirrer (not shown). The waste material to be recovered is diluted with the solvent (e.g. deionized water) typically at atmospheric pressure under heating at a temperature from about 30 to 70° C. to a preferred concentration of from about 8% to 45% gelatin by weight. Agitation is simultaneously performed to effect dissolution of the gelatin and the softening agent (e.g. glycerin).

A solution of gelatin and glycerin [i.e. solvent based layer (e.g. aqueous layer)] is thus formed within the remaining oily component and residual active-ingredient components [i.e. non-solvent based layer (e.g. non-aqueous layer)]. As used herein the term “solvent based layer” shall mean a layer or phase in which the components contained therein are dissolved in the solvent. The term “non-solvent based layer” shall mean a layer or phase in which the components therein do not dissolve in the solvent and therefore may be separated from the solvent based layer. Since water is the preferred solvent reference will be made hereinafter to the aqueous layer and nonaqueous layer.

The above recited concentration level of gelatin (from about 8% to 45%) is a preferred concentration for achieving rapid and thorough separation of the upper nonsolvent based layer (e.g. non-aqueous layer) from a lower solvent based layer (e.g. aqueous layer). The upper non-aqueous layer is either discarded or recycled. If recycled, the non-aqueous layer may be separated into oily components including, but not limited to, vitamins (for vitamin containing products (e.g. vitamin E)), mineral oil, garlic oil, fish oil, beta carotene, and vitamin E.

Once the gelatin is completely dissolved, agitation is terminated and the mass is allowed to either 1) stand to effect separation of the solvent based layer (e.g. aqueous layer) from the non-aqueous layer then further processed to remove residual oils and/or particulates or, 2) alternatively, the entire mass may be sent directly to an appropriate apparatus for separation of the aqueous and non-aqueous layers.

If the mass is allowed to stand to effect separation of the oils, it has been observed that for a batch size of about 150 Kg, for example, approximately 1 to 3 hours were required for separation. Separation of the lower aqueous layer from the upper non-aqueous layer can be facilitated by a sight glass incorporated into the recycling system. Accordingly, differences between the two layers are visually determined to effect accurate separation. Alternatively, an oil skimmer may be employed to remove the non-aqueous layer, as previously indicated, which is discarded or further processed in the recycle system, while the lower aqueous layer is further processed as discussed below.

The separation and recovery of the individual oily components within the nonaqueous layer of the recycling system can be accomplished by a variety of processes including, but not limited to, fractional distillation, short path distillation, and reverse osmosis.

In general, distillation is a process in which a liquid is vaporized, recondensed, and collected in a receiver. The liquid which has vaporized is collected in a receiver. The resultant liquid (i.e. condensed vapor) is referred to as the condensate or distillate.

Distillation is a process for purifying liquids by separating the liquid into its components. It is based on the difference in the volatility of the liquids. Volatility is a general term used to describe the relative ease with which molecules (liquid or solid) may escape from the surface to form a vapor. The vapor pressure of a liquid is related to the ease with which the liquid volatilizes (i.e. a relatively volatile substance exerts a relatively high vapor pressure at room temperature). The more volatile a substance, the higher its vapor pressure and the lower its boiling point.

Fractional distillation is the separation and purification, by distillation, of two or more liquids into various fractions. It is a systematic redistillation of progressively purer distillates or fractions. A fractionating column is used to essentially perform a large number of successive distillations without the necessity of actually collecting and redistilling the various fractions. A fractionating column may be packed with glass beads, glass helices, metal screens or ceramic saddles to effect fractionation.

A series of distillations involving partial vaporization and condensation concentrates the more volatile component in the first fraction of distillate and the less volatile component in the last fraction or in the residual liquid. The vapor leaves the surface of the liquid and passes up the packing of the column. The vapor condenses on the cooler surfaces and redistills, typically many times before entering the condenser. By means of long and efficient distillation columns, two liquids may be completely separated.

Short path distillation is especially suitable for substances that cannot be distilled by any of the ordinary distillation methods because (1) the substance is viscous, and any condensed vapors tend to plug the distilling column or condenser; and/or (2) the vapors of the substance are extremely susceptible to condensation.

Short path distillation differs from other distillations because (1) a condensed vapor flows to the distillate receiver or collector; (2) very low pressure (high vacuum) in the system favors vaporized molecules reaching the condensing surface without collision with other molecules to condense prematurely; (3) there is a very short distance between the surface of the evaporating liquid and the condenser surface; and (4) the substance has a residence time in the presence of heat which is very short so that thermal degradation is prevented.

A short path distillation apparatus typically includes a rotating still. Materials are fed into the rotating still and distributed evenly and thinly over a heated evaporating surface. The substance distills in a short time and the vapors condense and run into a collector. The degree of vacuum is controlled to collect the distillate effectively at the condenser. The pressure can be as low as 1 μm Hg.

Short path distillation as described herein is also known as molecular, wiped film, thin film, falling film, and rising film distillation. Short path distillation systems are commercially available from companies such as Pope Scientific in Saukville, Wis. and Artisan Industries in Waltham, Mass.

Reverse osmosis is a process whereby dissolved solids or a miscible liquid are removed from water by applying a pressure differential across a semi-permeable membrane. The semipermeable membrane allows water to flow therethrough, but does not allow other components from passing through the membrane. Reverse osmosis equipment is commercially available from companies such as Pall Filtron in Northborough, Mass. and Millipore Corporation in Bedford, Mass.

As described above, the dissolved gelatin is separated into a solvent based layer (e.g. aqueous layer) and a non-solvent based layer (e.g. non-aqueous layer). The nonaqueous layer is then treated by any of the above described methods to recover the oils contained in the non-aqueous stream.

If the separated aqueous layer contains particulates and/or oily type materials, the aqueous layer may then be treated, to remove residual oils and/or particulates by means of hot filtration processes as more fully described below.

The method of hot filtration employed for the removal of oils and/or particulates may include, but is not limited to, techniques such as liquid:liquid centrifugation, sub-micro/micro-filtration, liquid:liquid coalescers, absorbents and filter aids such as, but not limited to, diamataceous earth, activated carbon, clay or activated clay, colloidal silica, porous acrylic resins and the use of oil soluble salts to break any emulsion that may exist.

Liquid:liquid centrifugation is based on the principal that the rate of separation of two immiscible liquids is increased significantly by the application of centrifugal force which can be thousands of times that of gravity. The force exerted on the liquids is directly proportional to the speed of rotation, the radius of rotation, and the mass of the liquids.

The force exerted on rotating immiscible liquids, i.e, aqueous and non-aqueous liquids, is described in terms of relative centrifugal force or number of g's which is expressed as multiples of the force of gravity. Centrifuges are rated by their relative centrifugal force which can typically range from 10 to hundreds of thousands. Relative centrifugal force can be controlled by varying the speed or the centrifuge head or rotor.

As a method of hot filtration in the subject invention, the aqueous layer to be hot filtered is maintained at a temperature sufficient to allow flow into the centrifuge; higher temperatures and/or higher dilutions may also enhance an efficient separation by reducing the viscosity of the liquids to be separated. A temperature of from about 30° C. to 70° C. and a dilution volume of up to 5 volumes, preferably from about 0.5 to 5 volumes of a suitable solvent, such as water, is preferred.

The efficiency of separation may be enhanced by employing a relatively higher centrifugal force in the range of from about 5,000 to 25,000. The resulting, clarified aqueous layer containing gelatin and glycerin is collected for reuse and the residual oils and/or particulates are either discarded or collected for potential recovery as discussed hereinafter.

Liquid:liquid:solid centrifugation can also be utilized to achieve separation of the gelatin and softening agent (e.g. glycerin) from the particulates and/or residual oils. This procedure is preferred when the waste gelatin stream contains particulates which are at least a part of the coloring system (e.g. titanium dioxide).

Commercial liquid:liquid and/or liquid:liquid:solid centrifugation equipment is available from companies such as Westfalia Separator U.S. in Northvale, N.J. and Alfa Laval in Warminster, Pa.

Micro or sub-micro filtration refers to a method of removing small particles from a liquid. Particles as used herein include, but are not limited to, solid particulates which do not have sufficient mass to settle out of solution and/or emulsions and microemulsions which do not readily separate from a liquid. Micro or sub-micro filtration can be achieved through the use of micron or sub-micron pore sized filters including, but not limited to cartridge type filters and tangental flow type filters. Tangential flow type filters are the preferred filters for this purpose. The pore size of the preferred filters is typically in the range of from about 0.1 and 2.0 microns.

Temperature and dilution are important considerations in improving the efficiency of the filtration process by varying the viscosity of the liquid. A temperature of from about 30° C. to 70° C. and a dilution volume of up to 5 volumes preferably from about 0.5 to 5 volumes of a suitable solvent, such as water, is preferred.

Micro or sub-micro filtration equipment is commercially available from suppliers such as Pall Filtron in Northborough, Mass. and Millipore Corporation in Bedford, Mass.

A liquid:liquid coalescer, may be used to remove residual oils from the aqueous layer. The coalescer enhances the collection of the oil droplets (the dispersed phase liquid) into larger droplets which will separate more easily from the aqueous layer (the continuous phase liquid).

Generally, for the subject application, a multiple stage system may be employed to first remove particulates. Once the particulates are removed the remaining liquid may then be treated with a coalescer to remove residual oil from the aqueous gelatin and glycerin. A temperature of from about 30° C. to 70° C. and a dilution volume of typically up to 5 volumes, preferably from about 0.6 to 5 volumes of a suitable solvent, such as water, is desirable. Commercial coalescers are readily available such as those supplied by Pall Filtron of Northborough, Mass.

Filter aids containing diatomaceous earth can be employed for removal of particulates and/or residual oils. Diatomaceous earth, more commonly known as Celite or Filter Aid, is a very pure and inert material which forms a porous film or cake on a filter medium such as, but not limited to, filters made from paper, nylon and polypropylene as are typically used in filtration systems using filtration apparatus such as, but not limited to Nutsch filters, Rosenmund filters and/or centrifuges.

Diatomaceous earth can be employed: 1) by forming a slurry with an appropriate solvent, such as water, then filtering the slurry through an appropriate apparatus, such as a Nutsch or Rosenmund type filter, or a plate/coated plate filter such as a sparkler filter, to form a thin film or cake or 2) by adding the diatamaceous earth directly to the product to be filtered to form a slurry which is then filtered forming a porous thin cake or film. A temperature of from about 30° C. to 70° C. and a dilution volume of up to 5 volumes, preferably from about 0.5 to 5 volumes of a suitable solvent, such as water, is desirable. Other filter aids besides diatamaceous earth include, but are not limited to silica, acrylic resins, clay and activated carbon.

Absorbents which may be used to treat the solvent based layers include zeolitic materials.

The employment of the separation systems mentioned above separates particulates and/or oils from the aqueous layer containing gelatin and the softening agent (e.g. glycerin).

Depending on the concentration of the gelatin and glycerin in the resulting filtrate, the filtrate may be returned directly to gelatin mass manufacturing or the filtrate may be concentrated by removing some of the solvent (e.g. water). For solutions having a gelatin concentration greater than about 10% gelatin wt/wt (e.g. 10% wt/wt to 45% wt/wt), the aqueous solution may be charged to a concentration apparatus adapted for vacuum distillation such as disclosed in Schmidt et al., U.S. Pat. No. 5,288,408, or to a diafiltration system such as disclosed in Applicant's pending U.S. patent application Ser. No. 09/033,679, each of which is incorporated herein by reference. Alternatively, the filtrate may be subjected to short path distillation as previously described.

Short path distillation for this aspect of the present invention is carried out under controlled conditions to facilitate the removal of water at a lower temperature to prevent thermal degradation of the recoverable gelatin. Evaporator temperatures typically from about 50° C. to 120° C., and typically pressures 20 to 30 in. Hg, preferably 22-28 in. Hg are employed to remove water. Such temperatures and short contact time do not cause decomposition of the protein-based gelatin which affects its bloom strength. The water distillate is passed through a condenser to waste or recycle. The residue contains the gelatin/glycerin mixture for reuse.

As an example, waste gelatin material is diluted with solvent (e.g. water) at a ratio of 3:1, water:waste gelatin material, the following illustrates the distillate:residue ratios which may be via the chosen distillation process, to achieve a desired level of recycled gelatin and glycerin.

To achieve a 25% recycle level for gelatin and glycerin from the above described 3:1 dilution, the distillation should preferably result in a distillate: residue ratio of 50:50. To achieve a 40% recycle level for gelatin and glycerin from the above described 3:1 dilution, the distillation should preferably result in a distillate: residue ratio of 62.5:37.5. In both examples the residue contains the gelatin and glycerin for recycle.

It is understood that the above described recycling system may be incorporated into a conventional encapsulation apparatus to provide repeated or continual recycling of waste encapsulation materials.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications.

What is claimed is:

1. A method of treating a waste material containing gelatin comprising:
a) combining the waste material and a solvent for the gelatin to form a liquid containing gelatin;
b) separating the liquid into a solvent based layer and a non-solvent based layer; and
c) removing residual oils and/or particulates from the solvent based layer to form a second liquid containing gelatin having a higher purity than the first liquid.

2. The method of claim 1 further comprising treating the non-solvent based layer to remove and recover individual oils therefrom.

3. The method of claim 2 comprising distilling the non-solvent based layer.

4. The method of claim 3 wherein the step of distilling the non-solvent based layer comprises fractional distillation or short path distillation.

5. The method of claim 2 wherein the step of treating the non-solvent based layer comprises subjecting the non-solvent based layer to reverse osmosis.

6. The method of claim 1 wherein the step of removing residual oils and/or particulates from the solvent based layer comprises subjecting the solvent based layer to hot filtration.

7. The method of claim 6 wherein hot filtration is carried out at a temperature of from about 30 to 70° C.

8. The method of claim 7 wherein the solvent based layer is diluted at a dilution volume of up to 5 volumes of said solvent.

9. The method of claim 6 wherein the hot filtration step is selected from the group consisting of liquid:liquid centrifugation, submicro/microfiltration, liquid:liquid coalescence, absorbence and the use of filter aids.

10. The method of claim 9 comprising treating the solvent based layer with a tangential flow filter.

11. The method of claim 6 comprising removing the particulates and then removing the residual oils.

12. The method of claim 11 comprising removing the residual oils at a temperature of from about 30 to 70° C. and a dilution volume of up to 5 volumes using a liquid:liquid coalescer.

13. The method of claim 6 comprising removing the residual oils and particulates to form a filtrate and recycling the filtrate.

14. The method of claim 6 comprising removing the residual oils and particulates to form a filtrate and treating the filtrate to remove at least some of the solvent.

15. The method of claim 14 wherein the step of treating the filtrate comprises subjecting the filtrate to a process selected from the group consisting of vacuum distillation, diafiltration and short path distillation.

16. The method of claim 15 comprising treating the filtrate by short path distillation at an evaporator temperature of from about 50 to 120° C.

17. The method of claim 16 comprising treating the filtrate by short path distillation at a pressure of from about 20 to 30 in. Hg.

18. The method of claim 9 wherein the step of removing oils and particulates from the solvent based layer comprises subjecting the solvent based layer to centrifugation to form a third liquid containing gelatin.

19. The method of claim 1 further comprising separating the particulates from the oils and forwarding the oils to the non-solvent based layer.

20. The method of claim 18 further comprising removing at least a portion of the solvent from the third liquid to increase the concentration of gelatin in the third liquid.

21. The method of claim 20 further comprising removing any dyes from the third liquid.

22. The method of claim 1 wherein the waste material contains a softening agent, said softening agent being separated into the solvent based layer.

23. The method of claim 22 wherein the softening agent is selected from polyols.

24. The method of claim 23 wherein the polyol is glycerin.

25. The method of claim 20 wherein the third liquid contains a softening agent, said method further comprising subjecting the third liquid to short path distillation to form a fourth liquid containing gelatin, softening agent and dyes if present.

26. The method of claim 21 wherein the third liquid contains a softening agent, said method further comprising subjecting the third liquid to ultrafiltration to remove the softening agent and any dyes therefrom.

27. The method of claim 1 wherein the solvent is water.
